(19) United States
(12) Patent Application Publication
(10) Pub. No.: US 2010/0193510 A1
(43) Pub. Date: Aug. 5, 2010

(54) WIRELESS RADIATIVE SYSTEM

(76) Inventor: VLADIMIR A. DANILYCHEV, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 12/363,964

(22) Filed: Feb. 2, 2009

(51) Int. Cl. H05B 6/64

(52) U.S. Cl. 219/756

(57) ABSTRACT

In accordance with the present invention, there is provided a radiation system that includes at least one wireless radiative element which is powered with microwaves in a microwave cavity. The wireless element comprises a vacuum tight encapsulated envelope (i.e., a preliminarily evacuated tube) which is permeable to ultraviolet, visible and infrared light. The encapsulated envelope is filled with inert gas or inert gas mixtures under pressures in the range of about 0.1 to about 100 tors, and may contain additives of mercury and halogen gases. The microwave excitation of the one or more wireless radiative elements may be facilitated by the placement thereof inside a multi-mode microwave cavity with dimensions formulated in accordance with the teachings of Applicant's U.S. Pat. No. 5,931,557 entitled ENERGY EFFICIENT ULTRAVIOLET VISIBLE LIGHT SOURCE issued Aug. 3, 1999, the disclosure of which is incorporated herein by reference in its entirety.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field of the Invention

The present invention relates generally to infrared, ultra violet, and visible light sources, and more particularly to a multi-element radiation system which includes one or more wireless radiative elements and is particularly suited for applications including the drying of paints and coatings and radiative treatment of surfaces.

2. Description of the Related Art

Infrared, ultraviolet, and visible radiation is increasingly being used for a wide variety of applications in different industries. One such known radiation system which includes multiple radiators of different infrared (IR), ultraviolet (UV), and visible wavelengths based on heated metal wires, carbon ribbons and electrode wired UV lamps is described in U.S. Pat. No. 6,577,816 entitled INFRARED RADIATION SYSTEM WITH MULTIPLE IR RADIATORS OF DIFFERENT WAVELENGTHS issued Jun. 10, 2003. More particularly, U.S. Pat. No. 6,577,816 describes a radiation system that includes at least two elongated envelope tubes which are permeable to light and infrared radiation, and are joined together and sealed from ambient atmosphere. One of these tubes contains an incandescent coil which is electrically connected through sealed tube ends and external contacts to an external power supply, and emits infrared radiation in the near IR range. A second tube is provided with an elongated carbon strip as an infrared radiator for radiation in the medium IR range. Like the first tube, the second tube is itself connected through sealed ends and external contacts with the external power supply, or with an additional external power supply. The radiation system described in U.S. Pat. No. 6,577,816 may optionally include a third elongated tube which is joined to the first and second tubes and adapted to facilitate the emission of UV radiation.

Though U.S. Pat. No. 6,577,816 describes a radiation system which can be used, for example, in relation to the drying of paints and pigments, it possesses certain deficiencies which detract from its overall utility. The primary deficiency lies in the structural attributes of the IR generating envelope tubes, and the need to energize the incandescent coil or carbon radiator ribbon thereof through the use of a hard wired connection (consisting of terminal contacts) to one or more external power supplies. These hard wired connections add to the complexity of the radiation system, and result in a shortened effective operational lifespan for the IR producing envelope tubes. The present invention addresses these and other deficiencies in a manner which will be described in more detail below.

### BRIEF SUMMARY OF THE INVENTION

In accordance with the present invention, there is provided a radiation system that includes at least one wireless radiative element which is powered with microwaves in a microwave cavity. The wireless element comprises a vacuum tight encapsulated envelope (i.e., a preliminarily evacuated tube) which is permeable to ultraviolet, visible and/or infrared light. The encapsulated envelope is filled with inert gas or inert gas mixtures under pressures in the range of about 0.1 to about 100 tors, and may contain additives of mercury and halogen gases. The microwave excitation of the one or more wireless radiative elements may be facilitated by the placement thereof inside a multi-mode microwave cavity with dimensions formulated in accordance with the teachings of Applicant's U.S. Pat. No. 5,931,557 entitled ENERGY EFFICIENT ULTRAVIOLET VISIBLE LIGHT SOURCE issued Aug. 3, 1999, the disclosure of which is incorporated herein by reference in its entirety.

In more detail, as indicated above, each wireless radiative element integrated into the radiation system of the present invention is microwave excited, and comprises an encapsulated dielectric envelope or tube which is preliminarily evacuated and filled with a single inert gas or an inert gas mixture to a relatively low pressure in the range of about 0.1 to about 100 tors. Microwaves ignite an electrical discharge in the low pressure inert gas, and microwave power heats up the gas filled envelope to temperatures of up to about 200° C., depending on ambient air temperature and cavity cooling conditions. Multiple wireless radiative elements serving as IR and/or visible and UV radiators may be included in the radiation system, and are capable of heating up a particular target to temperatures of approximately 70° C. and above, and are further able to maintain the target at this elevated temperature in a length of time sufficient to dry a particular paint or coating applied thereto, or treat the surface of the target for moisture removal or disinfections.

In order to enhance the drying and/or treatment process, the encapsulated dielectric envelope of the wireless radiative element(s) integrated into the radiation system of the present invention can be made of glass, quartz, Vycor™, Pyrex™, sapphire, ceramics or other dielectric materials transparent to visible, infrared and/or ultraviolet light. Each envelope may further be fully or partially coated internally with phosphors which are adapted to emit desirable wavelengths which are matched to the coating or paint applied to the target, and provide the most efficient drying wavelength match to the color of the target. By way of example and not by way of limitation, for efficient excitation of UV, visible light and IR, mercury in metal or amalgamas form is added to the inert gas in a volume or quantity of greater than or equal to about 0.001 of the individual envelope volume. In addition to the foregoing, a dielectric reflective material may also be applied to the outer or inner surfaces of the envelope to effectively cover the elongated envelope along the full length thereof, leaving only a narrow window along the length of about 30° to about 180° for the more efficient transfer of UV, visible and IR light radiation from inside the envelope (and hence the wireless radiative element) to the target.

The present invention is best understood by reference to the following detailed description when read in conjunction with the accompanying drawings.

### BRIEF DESCRIPTION OF THE DRAWINGS

These, as well as other features of the present invention, will become more apparent upon reference to the drawings wherein:

FIG. 1 is a top perspective view of a wireless radiation system constructed in accordance with a first embodiment of the present invention;

FIG. 2 is a top perspective view of a wireless radiation system constructed in accordance with a second embodiment of the present invention;

FIG. 3 is a perspective view of a panel which may be integrated into the radiation system shown in FIGS. 1 or 2, and includes multiple wireless radiative elements;

FIG. 4 is a side-elevational view of one of the wireless radiative elements included in the panel shown in FIG. 3;

FIG. 5 is a cross-sectional view taken along line 5-5 of FIG. 4; and

FIG. 6 is a perspective view of a radiation system constructed in accordance with a third embodiment of the present invention.

Common reference numerals are used throughout the drawings and detailed description to indicate like elements.

### DETAILED DESCRIPTION OF THE INVENTION

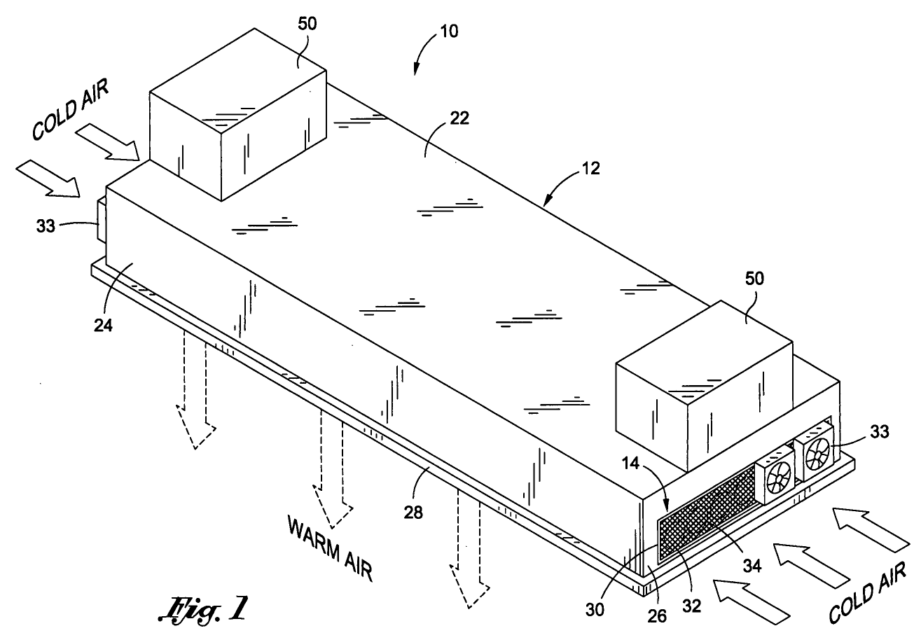

Referring now to the drawings wherein the showings are for purposes of illustrating preferred embodiments of the present invention only, and not for purposes of limiting the same, FIG. 1 illustrates an wireless radiative system 10 constructed in accordance with a first embodiment of the present invention. The system 10 comprises a housing 12 which defines a microwave cavity 14 having a volume Vo. More particularly, the housing 12 has a generally quadrangular (e.g., rectangular) configuration, and includes a top wall 22, an opposed pair of longitudinally extending side walls 24 which extend generally perpendicularly relative to the top wall 22, and an opposed pair of laterally extending side walls 26 which also extend generally perpendicularly relative to the top wall 22 and generally perpendicularly between the side walls 24. In addition to the top wall 22 and side walls 24, 26, the housing 12 includes a bottom wall 28 which is attached to the side walls 24, 26 so as to extend in spaced, generally parallel relation to the top wall 22. The bottom wall 28 preferably comprises a generally quadrangular (e.g., rectangular) frame having a metal mesh sheet or metal louver disposed within the interior thereof. The purpose for fabricating the bottom wall 28 to primarily comprise metal mesh sheet or metal louver will be discussed in more detail below. In the housing 12, the top and side walls 22, 24, 26 are each preferably fabricated from a sheet metal material formed of steel, stainless steel, aluminum, aluminum alloy, or nickel. Those of ordinary skill in the art will recognize that the shape of the housing 12 as shown in FIG. 1 is exemplary only, and that other shapes and sizes for the housing 12 are contemplated to be within the spirit and scope of the present invention, including but not limited to cylindrical, hollow cylinder, oval and other shapes.

As further seen in FIG. 1, each laterally extending side wall 26 and a corresponding laterally extending side of the outer frame of the bottom wall 28 collectively define at least one generally quadrangular (e.g., rectangular) opening 32 within the housing 12. Each opening 32 may also be formed in alternative shapes, such as an oval shape. Thus, the housing 12 includes at least a pair of openings 30 which are disposed in respective ones of the opposed lateral sides or ends thereof. Each opening 30 is preferably covered by a metal mesh sheet 32 or a metal louver which is identically configured to, though smaller in size than, the metal mesh sheet disposed within the interior of the outer frame of the bottom wall 28. The purpose for covering the openings 30 with respective ones of the metal mesh sheets 32 or metal louvers will also be discussed in more detail below. In the system 10, the microwave cavity 14 is collectively defined by the top wall 22, bottom wall 28 (including the metal mesh sheet thereof), and side walls 24, 26 (including the metal mesh sheets 32 or metal louvers). It is contemplated that the bottom wall 28 may be detachable from the remainder of the housing 12 for purposes of providing access to the microwave cavity 14.

In the system 10, it is contemplated that one or more air circulation fans 33 may be attached to the housing 12 adjacent the opening(s) 30 defined thereby. More particularly, as seen in FIG. 1, the fans 33 are positioned adjacent respective ones of the metal mesh sheets 32 or metal louvers so that, when activated, they are operative to facilitate the circulation of cool ambient air into and through the microwave cavity 14 of the housing 12 via respective ones of the openings 30. As will be recognized, the metal mesh sheets 32 or metal louvers covering each of the openings 30 are effectively disposed between the microwave cavity 14 and the circulation fans 33. Though two fans 33 are depicted in FIG. 1 as being positioned adjacent each metal mesh sheet 32 or metal louver, those of ordinary skill in the art will recognize that more or less than two fans 33 may be positioned adjacent each such metal mesh sheet 32 or metal louver without departing from the spirit and scope of the present invention.

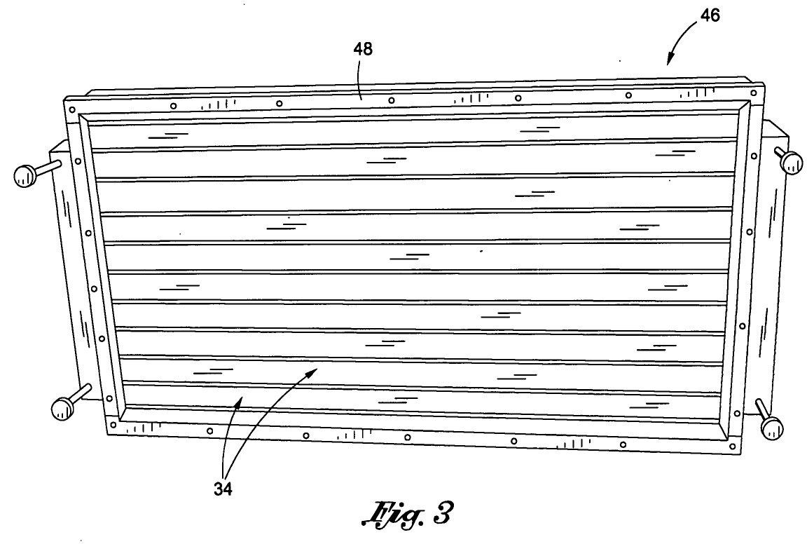

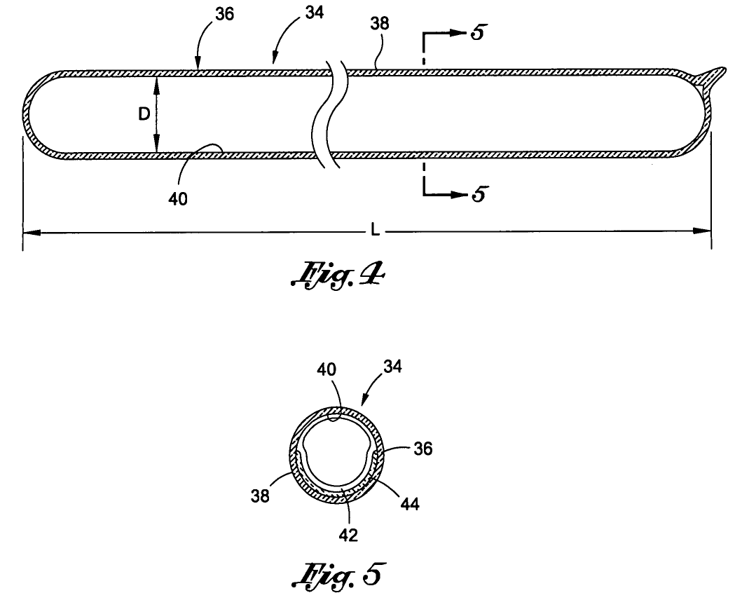

Disposed within the microwave cavity 14 is at least one, and preferably a number N of wireless radiative elements 34, which are shown in more detail in FIGS. 3-5. Each of the radiative elements 34 comprises an elongate, tubular body or envelope 36 which defines an outer surface 38 and an inner surface 40. The envelope 36 has an inner diameter D and an overall length L as shown in FIG. 4. In each radiative element 34 included in the system 10, the envelope 36 is preferably fabricated from a dielectric material which is transparent to ultraviolet and/or visible, and/or infrared light. Exemplary materials include, but are not limited to, glass, quartz, Vycor™, Pyrex™, sapphire, ceramics or other vacuum tight dielectric materials. The envelope 36 may also be fabricated from a microwave absorbing dielectric material such as, but not limited to, soft borosilicate glass, or ceramics. Additionally, as seen in FIG. 4, the envelope 36 preferably has a generally cylindrical configuration, with the length L being in the range of from about 5 inches to about 100 inches, and the diameter D being in the range of from about 0.1 inches to about 2.0 inches. The envelope 36, which is preliminarily evacuated, is filled with a single inert gas or an inert gas mixture to a relatively low pressure in the range of about 0.1 to about 100 tors. In this regard, each radiative element 34 is adapted to be microwave excited, with the exposure of each element 34 to microwaves being operative to ignite an electrical discharge in the low pressure inert gas or inert gas mixture contained within the envelope 36.

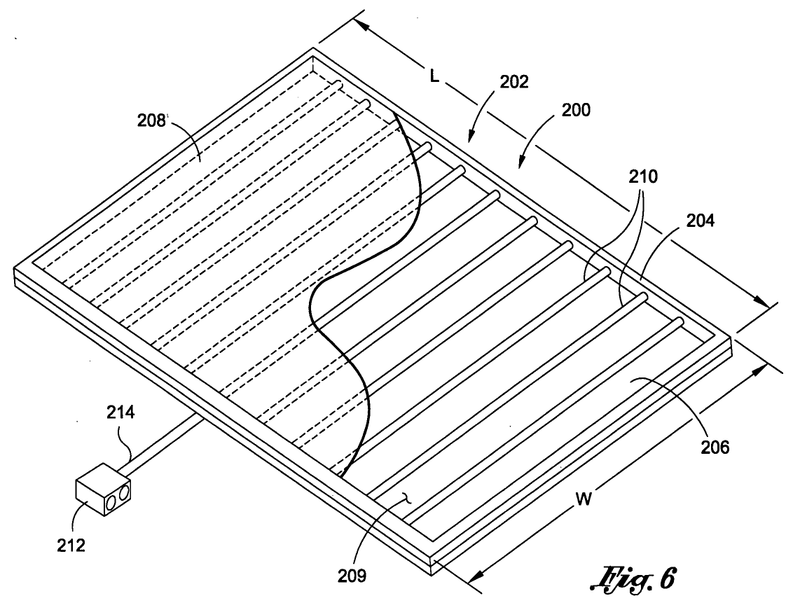

As seen in FIG. 5, it is contemplated that the inner surface 40 of the envelope 36 of each radiative element 34 may be fully or partially coated with a phosphor layer 42 which is adapted to cause the radiative element 34 to emit visible, infrared or ultraviolet light in a desired wavelength band when energized or excited by the exposure thereof to microwave power. More particularly, the phosphor layer 42 may comprise ultraviolet, visible, or infrared phosphors or blends of phosphors for the enhancement of radiation in specific wavelength bands or multiple bands related to the emission of the specific phosphor wavelengths. Such radiation emission wavelength band or multiple bands may be matched to the spectra of the most efficient drying or treatment wavelengths for specific paints or coatings and targets which are to be dried or cured by the ultraviolet, visible and/or infrared light produced by the system 10. In addition, to facilitate increased efficiency in the excitation of ultraviolet, visible light or infrared from each radiative element 34, it is contemplated that additives may be included in the inert gas or inert gas mixture. Such additive may comprise mercury in metal or amalgamas form which may be added to the inert gas within the envelope 36 of the radiative element 34 in a physical volume or quantity in a range of from about 0.001% to about 0.5% of the individual internal volume of the envelope 36, and preferably in a physical volume or quantity of greater than or equal to about 0.001% of the individual internal volume of the envelope 36. The additive may also comprise halogen containing gases such as, but not limited to, Cl2, F2, HCl, CCl4 or other halogen containing gases with pressures no more than about 1% of the total pressure of the inert gas or inert gas mixture.

In addition, it is contemplated that each radiative element 34 may include a dielectric reflective coating layer 44 which may be applied to a portion of the outer surface 38 or the inner surface 40 of the envelope 36. As seen in FIG. 5, if the reflective coating layer 44 is applied to a portion of the inner surface 40 of the envelope 36, the same is preferably covered by the internal phosphor layer 42 described above. The reflective coating layer 44, if included in the radiative element 34, preferably extends along the axis of the full length L of the envelope 36, and is formed so as to define a window (i.e., an area of the envelope 36 not covered by the reflective coating layer 44) which spans a circumferential distance in the range of from about 30° to about 180°. Such window is used to facilitate the transmission of ultraviolet, visible or infrared light from inside the envelope 36 of the radiative element 34 toward a prescribed target, as will also be discussed in more detail below. In the system 10, each radiative element 34 requires a nominal power p (in the form of microwave power) to facilitate the radiation of ultraviolet, visible or infrared light at a desired wavelength therefrom.

As seen in FIG. 3, the radiative elements 34 of the system 10 are preferably included in a radiative panel 46 which is disposed within the microwave cavity 14 and covers one side of the microwave cavity 14. The panel 46 includes a peripheral frame member 48 which is preferably fabricated from a material such as metal. The radiative elements 34 are arranged within the frame member 48 so as to extend between an opposed pair of sides thereof in substantially parallel relation to each other. The panel 46 is arranged within the microwave cavity 14 so as to extend between and in generally parallel relation to the top and bottom walls 22, 28 of the housing 12. The outer part of the panel 46 is covered with metal sheet mesh or a metal louver keeping microwaves inside the microwave cavity 14 and preventing their escape from the microwave cavity 14 to open space.

The system 10 further comprises at least one, or preferably pair or Nm of microwave magnetrons (or solid state) generators 50, each of which is disposed on the top wall 22 of the housing 12 and communicates with the microwave cavity 14. Each microwave magnetron generator 50 has a microwave power Pm, where P/Nm=Pm, and where P is a total microwave power of all microwave generators 50 together and produces microwaves having a wavelength λ. Though not shown, electrically connected to each of the generators 50 is a power supply. As shown in FIG. 1, the generators 50 are attached to the top wall 22 of the housing 12 so as to communicate directly with the microwave cavity 14. However, though not shown, the generators 50 may communicate with the microwave cavity 14 via waveguides. The microwave cavity 14 of the system 10 has a maximum cross-sectional dimension d which is greater than λ/2 for allowing microwaves to enter therein either directly from the generators 50 or from a waveguide.

In the first embodiment, the optimal operating condition for the system 10 to maximize the output and longevity of the wireless radiative elements 34, with individual radiative power p, diameter D, quantity N, length L, and minimize system power consumption is governed by the relationships:

Vo≧V min 1 wherein V min 1=8 πλ³/3 [formula (1)]

Vo>V min 2 wherein V min 2=π(D+1)² N L/4 [formula (2)]

P=kNp\sqrt{1+Vo/Vmin} [formula (3)]

wherein V min is the larger of V min 1 and V min 2, and k is a constant with a value in the range of 0.3≦k≦3 (low values of k are used in case of extended life time for the wireless radiative elements 34, while high values of k are used in the case of highest power and radiation production rate). In formulas (1), (2), and (3), the units for λ, D and L are in cm; the units for Vo, V min, V min 1, and V min 2 are in cm³; the units for p and p are in watts; and π=3.14.

In the operation of the system 10, the activation of the generators 50 facilitates the transmission of microwave power into the microwave cavity 14. As a result, the panel 46 disposed within the microwave cavity 14, and hence the radiative elements 34 thereof, are exposed to the microwaves, which facilitates the excitation of the radiative elements 34 in the aforementioned manner, and hence the transmission of ultraviolet, visible and/or infrared light therefrom. Importantly, the metal mesh sheet or metal louver of the bottom wall 28 of the housing 12 or panel 46, while being transparent to ultraviolet, visible and/or infrared light, does not allow microwaves to pass therethrough. As such, any parts or materials (i.e., targets) disposed below or adjacent the bottom wall 28 may be exposed to ultraviolet, visible and/or infrared light from the system 10, but will not be exposed to microwaves produced by the generators 50. Similarly, the metal mesh sheets 32 or metal louvers disposed within respective ones of the openings 30 defined by the housing 12 prevent the escape from microwaves from the housing 12, despite air being drawn into the interior of the housing 12 (i.e., the microwave cavity 14) via the openings 30.

Importantly, when the radiative elements 34 disposed within the panel 46 are energized or excited, the reflective coating layer 44 preferably included in each radiative element 34 is operative to concentrate the infrared, ultraviolet or visible light output thereof in a common direction which is preferably toward the metal mesh sheet or metal louver of the bottom wall 28 of the housing 12. It is contemplated that the panel 46 may be configured such that all of the radiative elements 34 therein are identical so that they each produce either ultraviolet light within a desired wavelength band, visible light in a desired wavelength band, and/or infrared light. However, if all of the radiative elements 34 of the panel 46 are identical and adapted to produce only one of infrared, ultraviolet or visible light when excited, it is contemplated that the panel 46 may be selectively changed out for one which includes radiative elements 34 adapted to transmit a different light when excited. As an alternative, the panel 46 may include a mix of radiative elements 34 which transmit ultraviolet, visible and/or infrared light in any combination of the three.

When the microwaves ignite an electrical discharge in the low pressure inert gas of each radiative element 34 included in the panel 46, such microwave power heats up the gas filled envelope 36 to a temperature of up to about 60° C. to about 200° C., depending on ambient air temperature and the cooling conditions of the microwave cavity 14. As a result, in the system 10, the multiple radiative elements 34 included in the panel 46 are capable of heating up a particular target which is exposed to the ultraviolet, visible, and/or infrared light produced by the system 10 to temperatures of approximately 60° C. and above, and are further capable of maintaining the target at this elevated temperature. In this regard, as is shown in FIG. 1, cool air drawn into the openings 30 and hence the microwave cavity 14 by the operation of the fans 33 is effectively circulated over the radiative elements 34 in the panel 46, thus effectively cooling the radiative elements 34. However, due to the above-described operating temperatures of the radiative elements 34, the circulating air is heated, and discharged through the metal mesh sheet of the bottom wall 28 to the target, thus elevating the temperature of the target in the aforementioned manner. Thus, the warm air produced by and exhausted from the system 10 may be used, in combination, with the ultraviolet, visible and/or infrared light produced thereby, to assist in the drying of a particular paint of coating applied to the target.

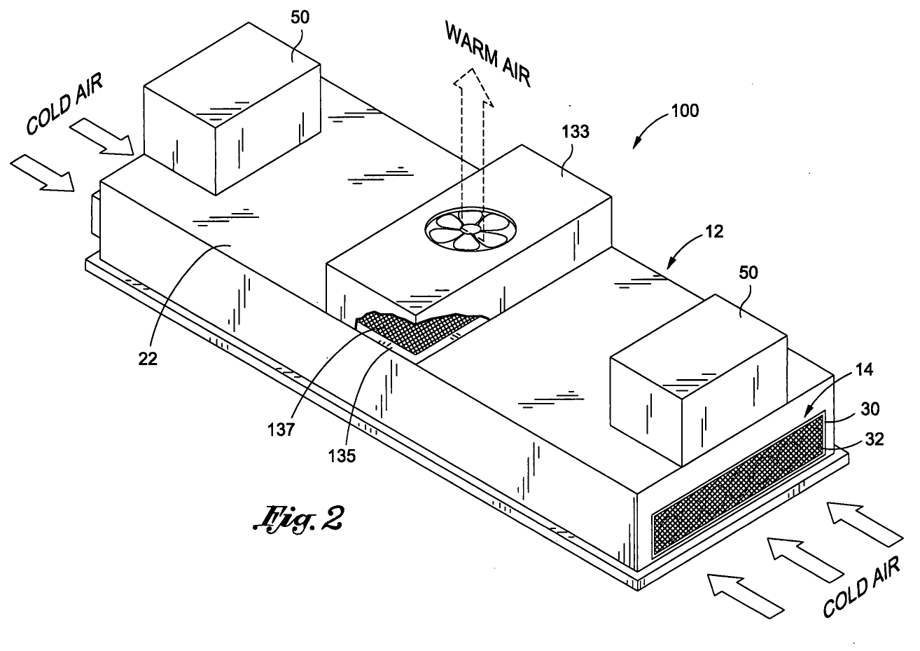

Referring now to FIG. 2, there is shown a wireless radiative system 100 constructed in accordance with a second embodiment of the present invention. The system 100 is substantially similar to the above-described system 10, with only the distinctions between the systems 10, 100 being described below.

The primary distinction between the systems 10, 100 lies in the substitution of the fans 33 described above in relation to the system 10, with the single fan 133 included in the system 100. More particularly, whereas the system 10 described above is adapted to facilitate the exposure of the target to warm air flow in addition to its exposure to ultraviolet, visible and/or infrared light produced by the system 10, the system 100 is adapted only to expose the target to the ultraviolet, visible and/or infrared light, and not to any warm air flow. In this regard, the sole circulation fan 133 included in the system 100 is attached to the top wall 22 of the housing 12 and fluidly communicates with the microwave cavity 14 via an opening 135 disposed within the top wall 22. As seen in FIG. 2, the opening 135 is covered by a metal mesh sheet 137 or metal louver which mimics the functionality of the metal mesh sheets 32, i.e., prevents the escape of microwaves from the microwave cavity 14 via the opening 135, while at the same time allowing heated air to be drawn from within and exhausted from the microwave cavity 14 upon the activation of the fan 133. In this regard, as is apparent from FIG. 2, the activation of the fan 133 effectively causes cool, ambient air to be drawn into the microwave cavity 14 via each of the openings 30 of the housing 12 which, as indicated above, are each covered by a respective one of the metal mesh sheets 32 or metal louvers. The air drawn into the microwave cavity 14 via the openings 30 is circulated over the radiative elements 34 within the panel 46, thereby effectively cooling the same when the radiative elements 34 are excited by the exposure thereof to microwaves. The heated air is drawn out of the microwave cavity 14 and exhausted by the fan 133 in a direction away from (i.e., opposite) the bottom wall 28, and hence the target.

Referring now to FIG. 6, there is shown a wireless radiative system 200 constructed in accordance with a third embodiment of the present invention. The system 200 comprises a housing 202 having a generally quadrangular (e.g., rectangular) configuration. More particularly, the housing 202 comprises a quadrangular peripheral frame 204 having a solid metal sheet 206 attached to one side thereof. It is contemplated that the frame 204 may be provided to have a length L in the range of from about 1 foot to about 10 feet, and a width W in the range of from about 1 foot to about 8 feet, or larger ranges. In addition, the housing 202 comprises a metal mesh sheet 208 or metal louver (shown partially in FIG. 6) which is attached to that side of the frame 204 opposite that having the solid metal sheet 206 attached thereto. In this regard, the metal sheet 206 and the metal mesh sheet 208 extend in spaced, generally parallel relation to each other, and are separated from each other by a gap having a width substantially equal to the thickness of the frame 204, i.e., the distance separating those sides of the frame 204 to which respective ones of the sheets 206, 208 are attached. In this regard, the frame 204 and the sheets 206, 208 collectively define a microwave cavity 209 of the housing 202. Though the housing 202 is shown as having generally rectangular configuration, those of ordinary skill in the art will recognize that other shapes for the housing 202 are contemplated to be within the spirit and scope of the present invention.

In addition to the housing 202, the system 200 comprises a plurality of wireless radiative elements 210 which are disposed in the microwave cavity 209. In particular, the radiative elements 210 are attached to and extend between the longitudinally extending sides of the frame 204 in spaced, generally parallel relation to each other in the manner shown in FIG. 6. Each of the radiative elements 210 is substantially identically configured to and functions in the same manner described above in relation to the wireless radiative elements 34 included in the systems 10, 100. In this regard, the sole distinction between the radiative elements 34, 210 lies in that it is contemplated that the radiative elements 210 included in the system 200 may each be fabricated to have a length in the range of from about 12 inches to about 96 inches.

The system 200 of the third embodiment further comprises a compact microwave power supply 212 which is connected to the microwave cavity 209 via a microwave wave guide 214 (e.g., a microwave cable or hollow metal wave guide) which may have a length of up to about 30 feet. The wave guide 214 is operative to communicate microwave power from the power supply 212 into the microwave cavity 209 of the housing 202. The system 200 of the third embodiment may comprise multiple microwave power supplies 212 which are connected to the microwave cavity 209 directly or via multiple microwave wave guides 214.

The system 200 operates in essentially the same manner described above in relation to the systems 10, 100. In this regard, the transmission of microwave energy from the power supply 212 into the microwave cavity 209 via the wave guide 214 facilitates the excitation of the radiative elements 210, and thus the transmission of ultraviolet, visible and/or infrared light therefrom. The metal mesh sheet 208 or metal louver, while being transparent to infrared, ultraviolet and/or visible light, does not allow microwaves to pass therethrough. As such, any targets disposed below or adjacent the metal mesh sheet 208 may be exposed to ultraviolet, visible and/or infrared light from the system 200, but will not be exposed to microwaves produced by the power supply 212. Though not shown, it is contemplated that the solid metal sheet 206 may optionally be replaced by a metal mesh sheet identical to the metal mesh sheet 208 or a metal louver, thus allowing infrared, ultraviolet and/or visible light to be transmitted from each side of the housing 209. In this instance, it is contemplated that none of the radiative elements 210 will include a reflective coating layer like the reflective coating layer 44 described above in relation to the radiative elements 34. It is also contemplated that the system 200 may be configured such that all of the radiative elements 210 therein are identical so that they each produce either infrared light within a desired wavelength band, ultraviolet light in a desired wavelength band, or visible light. As an alternative, the system 200 may include a mix of radiative elements 210 which transmit infrared, ultraviolet and/or visible light in any combination of the three.

The various embodiments described above may be used in various applications. Such applications include the illumination of objects such as photosensitive materials, and the infrared-ultraviolet-visible curing, solidifying or hardening of paints, polymer coatings, glues, etc. Other applications include stabilizing or etching semi-conductors, wafers or other substrates, sterilizing medical materials and instruments, and large area homogenous light illumination for displays, light emitting panels, and light emitting screens and walls. The various embodiments of the present invention are based on the fundamental principles of simultaneously and uniformally powering by microwave energy highly efficient infrared, ultraviolet and/or visible light/radiation producing radiative elements. Each embodiment of the present invention is economical to manufacture and is adapted to generate infrared, ultraviolet, and/or visible light, while being more compact and consuming lower levels of energy than prior art systems, and eliminating the expensive wiring and ballasts for multi-lamp light emitting systems.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A wireless radiative element, comprising:
an enclosed dielectric envelope permeable to ultraviolet, visible and/or infrared light, the envelope having a prescribed internal volume and defining inner and outer surfaces; and
an inert gas mixture filled within the envelope to a prescribed pressure level, and adapted to facilitate the transmission of at least one of ultraviolet, visible and/or infrared light when the radiative element is exposed to microwaves.

2. The radiative element of claim 1 wherein the envelope is fabricated from a dielectric material selected from the group consisting of:
glass;
ceramics;
quartz;
sapphire;
Pyrex™; and
Vycor™.

3. The wireless radiative element of claim 1 wherein the envelope is fabricated from a microwave absorbing dielectric material.

4. The wireless radiative element of claim 3 wherein the envelope is fabricated from borosilicate glass.

5. The radiative element of claim 1 wherein the inert gas mixture is filled into the envelope to a pressure in a range of about 0.1 tors to about 100 tors.

6. The radiative element of claim 5 further comprising an additive to the inert gas mixture of mercury in one of a metal and amalgamas form, and in a physical volume in a range of from about 0.001% to about 0.5% of the internal volume of the envelope.

7. The wireless radiative element of claim 5 further comprising an additive to the inert gas mixture of hydrogen or a halogen containing gas at a pressure of no more than about 0.1% of the pressure level of the inert gas mixture.

8. The wireless radiative element of claim 7 wherein the halogen containing gas is selected from the group consisting of:
C12;
F2;
HCl; and
CCl4.

9. The wireless radiative element of claim 1 wherein the envelope has an elongate, cylindrical configuration having an inner diameter of about 0.1 to about 2.0 inches, and a length of from about 5 to about 100 inches.

10. The wireless radiative element of claim 1 further comprising a phosphor layer applied to at least a portion of the inner surface of the envelope to facilitate the transmission of at least one of infrared, ultraviolet, and visible light in at least one wavelength band.

11. The wireless radiative element of claim 10 wherein the phosphor layer applied to the inner surface of the element is selected such that a phosphor emission wavelength band is substantially matched to the spectra of a drying wavelength for a prescribed substance.

12. The wireless radiative element of claim 10 further comprising a dielectric reflective coating layer applied to the outer surface of the envelope, covering at least a portion of the envelope along an axis thereof and defining a window having a circumferential span in a range of about 30° to about 180°.

13. The wireless radiative element of claim 12 wherein the reflective coating layer is applied to the inner surface of the envelope and is at least partially covered by the phosphor layer.

14. The wireless radiative element of claim 1 further in combination with at least one additional wireless radiative element, the wireless radiative elements extending in side-by-side relation to each other in a radiative panel.

15. The wireless radiative element of claim 14 wherein the radiative elements within the radiative panel are identically configured to each other and adapted to transmit one of infrared, ultraviolet and visible light when the radiative panel is exposed to microwaves.

16. The wireless radiative element of claim 14 wherein the radiative panel includes a plurality of the wireless radiative elements extending in side-by-side relation to each other, and at least some of the radiative elements within the radiative panel are not identically configured to each other and adapted to transmit one of infrared, ultraviolet and visible light when the radiative panel is exposed to microwaves.

17. The wireless radiative element of claim 14 further in combination with at least one fan adapted to circulate air over the radiative panel and toward a prescribed drying target.

18. The wireless radiative element of claim 14 further in combination with at least one fan adapted to circulate air over the radiative panel and away from a prescribed drying target.

19. A wireless radiative element, comprising:
an enclosed dielectric envelope having a prescribed internal volume; and
an inert gas filled within the envelope to a pressure level in a range of about 0.1 tors to about 100 tors, and adapted to facilitate the transmission of one of infrared, ultraviolet and visible light when the radiative element is exposed to microwaves.

20. A wireless radiative element, comprising:
an enclosed dielectric envelope permeable to infrared, ultraviolet and visible light, the envelope having a prescribed internal volume and defining inner and outer surfaces;
an inert gas filled within the envelope to a prescribed pressure level, and adapted to facilitate the transmission of one of infrared, ultraviolet and visible light when the radiative element is exposed to microwaves;
a phosphor layer applied to at least a portion of the inner surface of the envelope to facilitate the transmission of one of infrared, ultraviolet, and visible light in at least one wavelength band; and
a dielectric reflective coating layer applied to at least a portion of the envelope along an axis thereof.
